(19) United States
(12) Patent Application Publication
(10) Pub. No.: US 2014/0089557 A1
(43) Pub. Date: Mar. 27, 2014

(54) IMAGE STORAGE OPTIMIZATION IN VIRTUAL ENVIRONMENTS

(71) Applicant: International Business Machines Corporation, Armonk, NY (US)

(72) Inventors: Sukadev Bhattiprolu, Beaverton, OR (US); Mingming Cao, Portland, OR (US); Venkateswararao Jujjuri, Beaverton, OR (US); Haren Myneni, Tigard, OR (US); Malahal R Naineni, Tigard, OR (US); Badari Pulavarty, Beaverton, OR (US); Chandra Seetharaman, Portland, OR (US); Narasimha Sharoff, Beaverton, OR (US)

(73) Assignee: International Business Machines Corporation, Armonk, NY (US)

(21) Appl. No.: 14/095,215

(22) Filed: Dec. 3, 2013

Related U.S. Application Data
(63) Continuation of application No. 13/216,136, filed on Aug. 23, 2011.

(51) Int. Cl. G06F 17/30; G06F 9/455

(52) U.S. Cl. CPC G06F 17/30091; G06F 9/455
USPC 711/6

(57) ABSTRACT

A method for monitoring and managing virtual machine image storage in a virtualized computing environment is proposed, where the method for managing storage utilized by a virtual machine can include identifying one or more unused disk blocks in a guest virtual machine image, and removing the unused disk blocks from the guest virtual machine image.

### CROSS-REFERENCE TO RELATED APPLICATIONS

This is a continuation application of and claims priority to U.S. patent application Ser. No. 13/216,136 entitled “IMAGE STORAGE OPTIMIZATION IN VIRTUAL ENVIRONMENTS” and filed on Aug. 23, 2011 for Sukadev Bhattiprolu, et al., which is incorporated herein by reference.

### FIELD

The present invention relates generally to virtual machines and more particularly to methods of optimizing the storage of image files in virtual machine filesystems.

### BACKGROUND

A “virtual machine” (or VM) may be thought of as a “virtual” (software) implementation of a physical processing device. As an example, a computer may be partitioned into many independent virtual machines, or VM images, each capable of supporting and executing their own operating system and applications. A virtual machine monitor/manager (VMM or “hypervisor”) typically functions as the primary resource manager, managing the interaction between each VM image and the underlying resources provided by the hardware platform. The hypervisor can support the operation of multiple VM images, or guest operating system images, limited only by the processing resources of the VM container holding the VM images or the hardware platform itself.

An assortment of virtual machines are currently in use. They may range from runtime environments for high-level languages, like Java and Smalltalk, to hardware-level VMMs such as VMware, KVM and Xen.

### BRIEF SUMMARY

Embodiments of the present invention address deficiencies of the art in respect to virtualization and provide a method, system and computer program product for monitoring and managing virtual machine image storage in a virtualized computing environment.

In this regard, a method for managing storage utilized by a virtual machine can include identifying one or more unused disk blocks in a guest virtual machine image, and removing the unused disk blocks from the guest virtual machine image. In one embodiment, the method is performed by the hypervisor when the virtual machine is in an offline state.

In one embodiment, identifying the one or more unused disk blocks includes iterating through one or more allocation bitmaps for the guest virtual machine image and logging blocks marked as free within the guest virtual machine image. In a further embodiment, removing the unused disk blocks from the guest virtual machine image includes converting the logged blocks into corresponding offsets in the host filesystem backing file, and removing the logged blocks from the virtual machine image by marking the corresponding offsets as unneeded. In another embodiment, removing the unused disk blocks from the guest virtual machine image includes making a copy of the guest virtual machine image that omits the contents of the logged blocks, and replacing the guest virtual machine image with the copied guest virtual machine image.

In another embodiment, the method includes determining whether the hypervisor is capable of converting the logged blocks into corresponding offsets in the host filesystem backing file and removing the logged blocks from the virtual machine image by marking the corresponding offsets as unneeded. In another embodiment, the method includes converting the logged blocks into corresponding offsets in the host filesystem backing file, and removing the logged blocks from the virtual machine image by marking the corresponding offsets as unneeded. In another embodiment, the method includes making a copy of the guest virtual machine image that omits the contents of the logged blocks, and replacing the guest virtual machine image with the copied guest virtual machine image.

In an alternative embodiment, a virtualization data processing system can include a hypervisor configured for execution in a host computing platform, and a virtual machine image in a host filesystem managed by the hypervisor, provided that the hypervisor is adapted to identify one or more unused disk blocks in the virtual machine image and remove the unused disk blocks from the virtual machine image, while the virtual machine is in an offline state. In one embodiment, the hypervisor is configured to identify the one or more unused disk blocks by iterating through one or more allocation bitmaps for the virtual machine image and logging blocks marked as free. In another embodiment, the hypervisor is configured to convert the logged blocks into corresponding offsets in a host filesystem backing file, and remove the logged blocks from the virtual machine image by marking the corresponding offsets as unneeded. In yet another embodiment, the hypervisor is configured to make a copy of the guest virtual machine image that omits the contents of the logged blocks, and replace the guest virtual machine image with the copied guest virtual machine image.

A computer program product for managing storage used by a virtual machine in a virtualized computing environment can include a computer usable medium having computer usable code embodied therewith, where the computer usable code includes computer usable program code for identifying one or more unused disk blocks in a virtual machine image, and computer usable program code for removing the unused disk blocks from the virtual machine image while the virtual machine is in an offline state, where the computer usable code is executable by a hypervisor controlling the virtual machine. In one embodiment, the computer program product includes computer usable program code for identifying the unused disk blocks by iterating through one or more allocation bitmaps for the virtual machine image and logging blocks marked as free.

In another embodiment, the computer program product includes computer usable program code for converting the logged blocks into corresponding offsets in a host filesystem backing file, and removing the logged blocks from the virtual machine image by marking the corresponding offsets as unneeded. In yet another embodiment, the computer program product includes computer usable program code for making a copy of the virtual machine image that omits the contents of the logged blocks, and replacing the guest virtual machine image with the copied virtual machine image.

### BRIEF DESCRIPTION OF THE DRAWINGS

FIG. 1 is a schematic representation of a virtualization data processing system configured to manage storage used by a virtual machine image, according to an embodiment of the present invention;

FIG. 2 is a flowchart illustrating a method of managing storage utilized by a virtual machine, according to an alternative embodiment of the invention;

FIG. 3 is a flowchart illustrating a method of managing storage utilized by a virtual machine, according to yet another alternative embodiment of the invention; and

FIG. 4 is a continuation of the flowchart of FIG. 3.

### DETAILED DESCRIPTION OF THE INVENTION

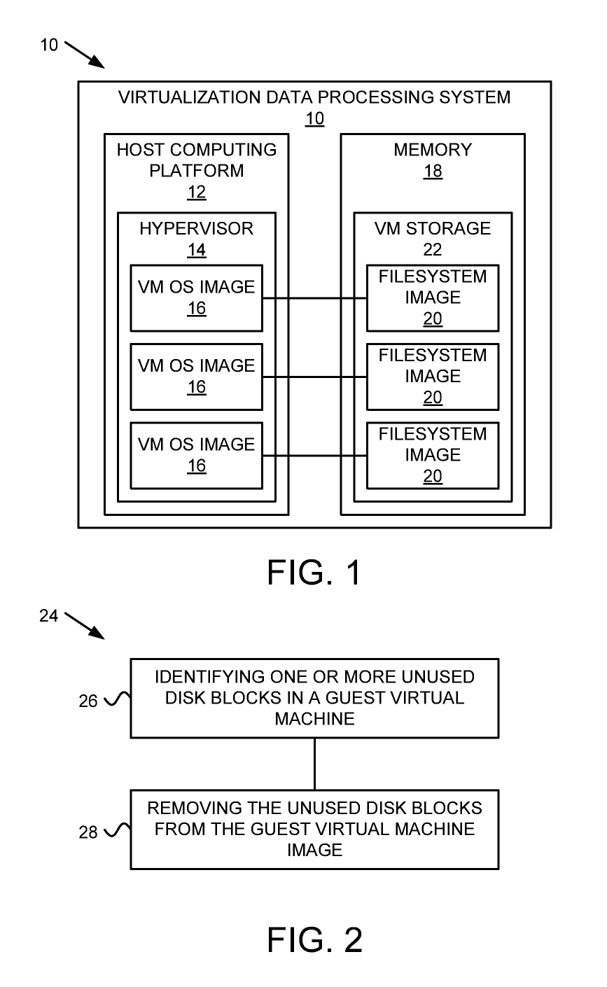

FIG. 1 is a schematic illustration of a virtualization data processing system 10 configured to manage storage used by a virtual machine image, according to an embodiment of the invention. As shown, the host computing platform 12 supports the operation of a virtual machine monitor, or hypervisor 14, which is configured to manage one or more different virtual machine operating system images 16. Each of the virtual machine operating system images (or VM OS images) can provide a guest computing environment, including a virtual guest operating system, for executing one or more virtual machine applications.

The hypervisor 14 typically establishes a configuration for each individual VM OS image operating on the host computing platform 12. Each guest VM OS image 16 resident on the host computing platform 12 may utilize a guest filesystem 20 to manage VM files within the allocated storage 22 for the VM, as coordinated by hypervisor 14. Each guest filesystem 20 may be localized to a virtual hard disk that is resident on one or more physical storage media 18, where the guest filesystem images are managed and coordinated by hypervisor 14. Physical storage media 18 may include any apparatus that can provide appropriate data storage associated with a VM image. The medium can be an electronic, magnetic, optical, electromagnetic, infrared, or semiconductor system (or apparatus or device), and may include one or more of semiconductor or solid state memory, magnetic tape, a random access memory (RAM), a rigid or flexible magnetic disk, or an optical disk, among others. Typically, the physical memory associated with the VM image will include one or more of a magnetic disk drive, flash memory, or solid-state memory.

The VM filesystem may be sparse, containing only the valid data for the initial image, but depending on the allocation given by the hypervisor, the filesystem may become relatively large, growing in size as additional storage is needed by the VM image. As a user within the guest VM deletes files, the disk blocks corresponding to those files are typically marked free for future use. However, the hypervisor 14 may not be informed that the resulting free disk blocks no longer contain valid data, and could therefore be removed. As a result, while the VM files within the filesystem image can increase in size as their allocation is increased, their allocation may never decrease, even when the guest VM image is no longer using all of its allocated disk space. This results in an inefficient use of available storage, potentially limiting the number of guest VMs that can be deployed by the hypervisor at any given time.

A method of managing storage resources utilized by a virtual machine is depicted in flowchart 24 of FIG. 2, according to an exemplary embodiment of the present invention. The method of flowchart 24 may be used where a virtual machine is resident on a host computing platform, and includes a guest virtual machine image in a host file system. The method itself is typically performed by a hypervisor running on the host computing platform adapted to manage the virtual machine image. The flowchart includes identifying one or more unused disk blocks in a guest virtual machine image at 26, and then removing the unused disk blocks from the guest virtual machine image at 28.

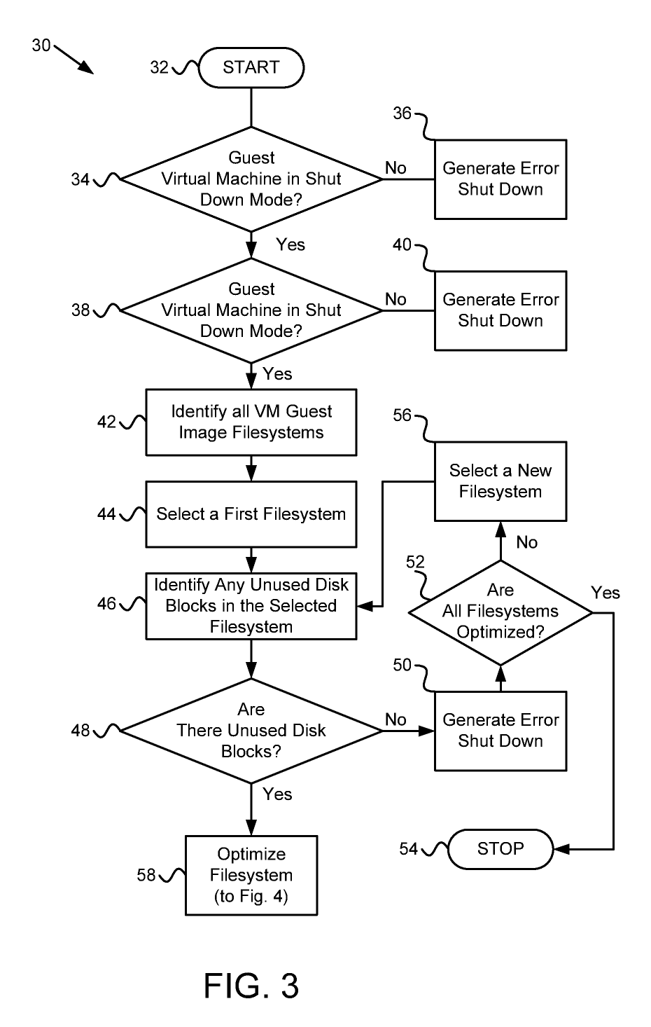

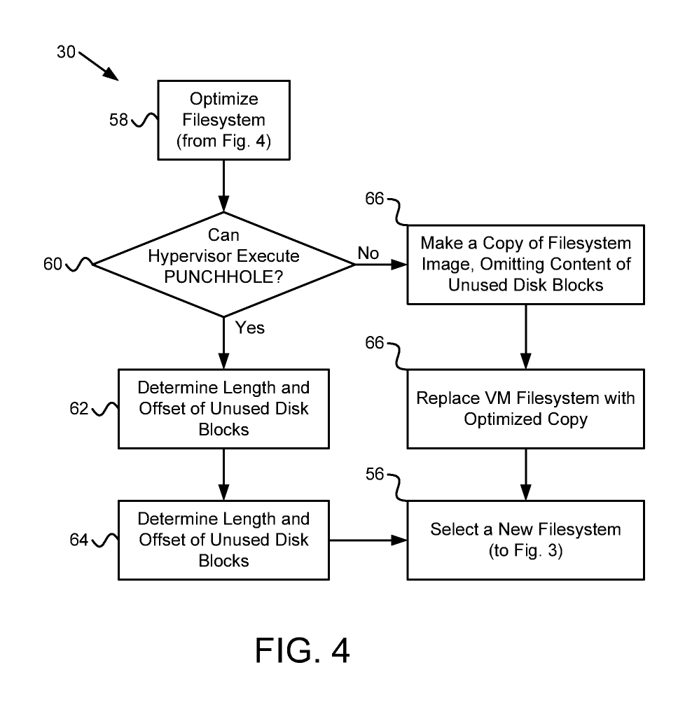

FIGS. 3 and 4 depict an illustrative example of an implementation of the method described in FIG. 2. An advantage of the process depicted in FIGS. 3 and 4 is the elimination of any need for modification and handshake between the host and hypervisor, and no requirement for the hypervisor to scan for specific IO patterns in the filesystem images.

Referring to FIG. 3, flow diagram 30 depicts a process to be executed by the hypervisor to optimize the filesystem image for a selected VM OS image, beginning with the start block 32. Initially, the hypervisor determines whether the guest VM is in a shutdown state, at block 34. If the VM is not in a shutdown state, the hypervisor generates an error message and the optimization process is terminated, at block 36.

The hypervisor then verifies that the VM image has a recognizable format, at block 38. If the hypervisor fails to recognize the format used by the VM image, the hypervisor generates an error, and the optimization process is terminated, at block 40.

After having verified that the VM is in a shutdown state, and that the hypervisor recognizes the format used by the guest VM, the hypervisor then identifies all guest image filesystems associated with the selected guest VM, at block 42. Having identified all guest image filesystems, the hypervisor selects a first filesystem for optimization, at block 44.

The hypervisor then scans the selected filesystem, and identifies any unused disk blocks in the selected filesystem, at block 46. Any methodology that can be used by the hypervisor to identify unused disk blocks is a suitable methodology. Typically, the hypervisor would invoke a tool for carrying out such identification. The tool could be configured to walk through the guest filesystem allocation bitmaps and identify each disk block within the guest filesystem that is free and record its location. In one aspect of the invention, such a tool could be referred to as a “checkfree” tool.

As depicted in block 48 of flowchart 30, if the hypervisor determines that there are no unused disk blocks in the image filesystem, the selected filesystem is therefore optimized, as shown at block 50. The hypervisor then determines whether any filesystems remain that include unused disk blocks, at block 52. If any filesystem remains that contains unused disk blocks, the hypervisor then selects a new filesystem for optimization, as shown at block 56. In this way the hypervisor may analyze all filesystems in the VM OS image iteratively. In one aspect of the present invention, the hypervisor iterates the entire directory tree of a selected filesystem image.

Where the query of block 48 results in a determination that unused disk blocks exist, the hypervisor then begins the optimization process, as shown at block 58. As shown on FIG. 4, optimization may begin with a determination of whether the hypervisor is configured to utilize a tool referred to herein as “punchhole,” at block 60. The punchhole tool corresponds to any executable tool that, if provided with a list of block numbers for unused disk blocks, determines the length and byte offset of the unused disk blocks in the host backing file, as set out at block 62, and punches a hole at the corresponding location, at block 64. By “punching a hole” is meant any operation wherein a portion of a disk file can be marked as unwanted and the associated storage released.

Where the hypervisor is unable to execute a punchhole-type operation, the hypervisor can instead execute an operation that copies the filesystem image, as set out at block 66, without copying the content of the disk blocks previously identified as unused, as set out at block 46 of FIG. 3. The resulting optimized image copy is then used to replace the original unoptimized filesystem image, at block 68.

Regardless of whether the punchhole protocol or the image copy protocol is followed, once the filesystem image has been optimized and all unused disk blocks have been released for use, the iterative process of analyzing the entire filesystem continues at block 56, with the selection of a new filesystem image for identification of unused disk blocks. If all filesystems have been optimized, that is, none of the guest VM image filesystems have any unused disk blocks, the optimization process halts, as reflected by STOP block 54.

Embodiments of the present invention can take the form of an entirely hardware embodiment, an entirely software embodiment or an embodiment containing both hardware and software elements. In one embodiment, the invention may be implemented in software, which includes but is not limited to firmware, resident software, microcode, and the like. Furthermore, the invention may take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Selected examples of optical disks include compact disk-read only memory (CD-ROM), compact disk-read/write (CD-R/W) and DVD.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The flowchart and block diagrams provided in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for managing storage utilized by a virtual machine; where the virtual machine is resident on a host computing platform and includes a guest virtual machine image in a host file system; and where the method is performed by a hypervisor running on the host computing platform, the hypervisor being adapted to manage the virtual machine image; the method comprising:
identifying one or more unused disk blocks in the guest virtual machine image; and
removing the unused disk blocks from the guest virtual machine image.

2. The method of claim 1, wherein the method is performed by the hypervisor when the virtual machine is in an offline state.

3. The method of claim 1, wherein identifying the one or more unused disk blocks includes iterating through one or more allocation bitmaps for the guest virtual machine image and logging blocks marked as free within the guest virtual machine image.

4. The method of claim 3, wherein removing the unused disk blocks from the guest virtual machine image includes converting the logged blocks into corresponding offsets in the host file system backing file, and removing the logged blocks from the virtual machine image by marking the corresponding offsets as unneeded.

5. The method of claim 3, wherein removing the unused disk blocks from the guest virtual machine image includes making a copy of the guest virtual machine image that omits the contents of the logged blocks, and replacing the guest virtual machine image with the copied guest virtual machine image.

6. The method of claim 3, wherein the method further comprises determining whether the hypervisor is capable of converting the logged blocks into corresponding offsets in the host file system backing file and removing the logged blocks from the virtual machine image by marking the corresponding offsets as unneeded.

7. The method of claim 6, further comprising converting the logged blocks into corresponding offsets in the host file system backing file, and removing the logged blocks from the virtual machine image by marking the corresponding offsets as unneeded.

8. The method of claim 6, further comprising making a copy of the guest virtual machine image that omits the contents of the logged blocks, and replacing the guest virtual machine image with the copied guest virtual machine image.
